(19) United States
(12) Patent Application Publication
(10) Pub. No.: US 2006/0259769 A1
(43) Pub. Date: Nov. 16, 2006

(54) Method and device for encryption and decryption

(75) Inventors: Rainer Goettfert, Taufkirchen (DE); Erwin Hess, Ottobrunn (DE); Bernd Meyer, Munich (DE); Steffen Sonnekalb, Taufkirchen (DE)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: Infineon Technologies AG, Munich (DE)

(21) Appl. No.: 11/397,028

(22) Filed: Mar. 30, 2006

Related U.S. Application Data
(63) Continuation of application No. PCT/EP04/09062, filed on Aug. 12, 2004.

(30) Foreign Application Priority Data
Sep. 30, 2003 (DE) 10 345 457.8

(51) Int. Cl. H04L 9/00

(52) U.S. Cl. 713/168

(57) ABSTRACT

Applying both an encryption and also a decryption algorithm, which is inverse to the encryption algorithm, as an encryption definition to thereby enable the use of an encryption unit and a decryption unit of an encryption/decryption device simultaneously, i.e. temporally overlapping, in an encryption process when a part of the data to be encrypted is supplied to the encryption unit while the other part is supplied to the decryption unit. The result is encrypted data or is a cipher text, respectively, whose parts are only “encrypted” in a different way. During decryption, it only has to be guaranteed by suitable regulations that those parts which were encrypted by the encrypted unit are again decrypted by the decryption unit, while the other parts which were “encrypted” by the decryption unit are “decrypted” by the encryption unit.

### CROSS-REFERENCE TO RELATED APPLICATION

This application is a continuation of copending International Application No. PCT/EP2004/009062, filed Aug. 12, 2004, which designated the United States and was not published in English, and is incorporated herein by reference in its entirety.

### BACKGROUND OF THE INVENTION

1. Field of the Invention

The present invention generally relates to an encryption/decryption scheme as it is applicable for example for a protection of memory contents against an unauthorized readout.

2. Description of Related Art

In a data storage which is secured against unauthorized spying-out, the data to be stored is not stored in clear text, i.e. unencrypted, but in an encrypted form, as a so-called cipher or a so-called cipher text. If the data is to be read at a later point in time, therefore obviously they have to be decrypted again before they may be processed. Examples for applications in which this effort for storing is worthwhile are manifold and for example include chip cards, smart cards or magnetic cards, on which for example information to be protected, like amounts of money, keys, account numbers etc. are to be protected from an unauthorized access.

FIG. 5 again illustrates the circumstances. Data to be protected is stored in an encrypted form, designated as a cipher domain in FIG. 5, in order not to surrender the same unprotectedly to potential attackers. Outside the cipher domain, the data to be protected is present in clear text, designated as a clear text domain in FIG. 5. The border between clear text and cipher domain is indicated by a dash-dotted line in FIG. 5. An interface between clear text and cipher domain is formed by an encryption/decryption device 900. The encryption/decryption device 900 is provided to encrypt non-encrypted data to be stored from the clear text domain and to output the same in an encrypted form to the cipher domain for storing, and vice versa, when requesting or reading out this data, to again decrypt the data to be read out which are now again present in an encrypted form in order to output the same in clear text to the clear text domain. The underlying encryption scheme is a symmetrical encryption, i.e. one in which the inverse encryption, i.e. the decryption, may be performed with about the same effort as the encryption. The encryption/decryption device 900 thus consists of two approximately equally-sized or equally-expensive parts regarding their implementation, respectively, i.e. of an encryption unit or an encryption part 902 and a decryption unit or a decryption part 904, respectively. The encryption unit 902 maps data at an encryption input of the same after a certain encryption algorithm block-wise to encrypted data and outputs the same to an encryption output of the same. In the device 900, the encryption unit 902 is provided such that it receives data blocks B₁, . . . , B_{N} wherein N ε |N to be stored, which are present in clear text, at its encryption input, so that the encryption unit 902 outputs encrypted data blocks C₁, . . . , C_{N}, the so-called cipher text, at the encryption output. The decryption unit 904 is responsible for the opposite direction, i.e. not for the storing of data but for reading out data from the storage in the cipher domain into the clear text domain. Accordingly, the decryption unit 904 is implemented to map data at its decryption input to decrypted data according to a decryption algorithm which is inverse to the encryption algorithm of the encryption unit 902, and outputs this decrypted data at a decryption output of the same. In the device 900, the decryption unit 904 is provided so that it receives data blocks C₁, . . . , C_{N} to be read out and stored in encrypted form at the data input, decrypts this cipher text C₁, . . . , C_{N} block by block and outputs the data blocks B₁, . . . , B_{N} in clear text to the clear text domain at the decryption output.

The disadvantage of the encryption/decryption device 900 of FIG. 5 now is the following. Inca usage in connection with a microprocessor, at a certain point in time, data is either encrypted, i.e. in a write operation, or it is decrypted, i.e. in a read operation. Thus, if at all, at a certain time always only half of the hardware of the encryption/decryption device 900 is in operation, while the other one is idle. Only the encryption part 902, that is when a write operation is performed and thus an encryption is performed, or the decryption part 904, when a read operation is performed and thus a decryption is performed, is active, but never both at the same time.

Although there may be applications in which this approach is not a problem, as the number of pieces is low, so that the increased chip space requirement for the provision of the encryption unit on the one and the decryption unit on the other hand, which never operate simultaneously, is reasonable, it would be desired with mass-produced articles, like e.g. chip cards, smart cards etc., to have a more effective form of an encryption/decryption scheme which uses the available hardware better, so that the increased chip space requirement would be justified by another advantage.

### SUMMARY OF THE INVENTION

The present invention provides an encryption/decryption scheme according to which it is possible to perform an encryption and decryption with substantially the same implementation expense but with less time expense.

In accordance with a first aspect, the present invention provides a device for encrypting data to be encrypted into encrypted data and for decrypting data to be decrypted into decrypted data, having an encryption unit comprising an encryption input and an encryption output for mapping data applied to the encryption input to an encryption result at the encryption output according to an encryption mapping; a decryption unit comprising a decryption input and a decryption output for mapping data applied to the decryption input to a decryption result at the decryption output according to a decryption mapping which is inverse to the encryption mapping; and a controller for applying a first part of the data to be encrypted to the encryption input and a second part which is different from the first part of the data to be encrypted to the decryption input in order to obtain the encrypted data, in the case that the device is to perform an encryption, and for applying a part of the data to be decrypted to the decryption input and a second part which is different from the first part of the data to be decrypted to the encryption input in order to obtain the decrypted data, in the case that the device is to perform a decryption.

In accordance with a second aspect, the present invention provides a device for encrypting data to be encrypted into encrypted data, having an encryption unit comprising an encryption input and an encryption output for mapping data applied to the encryption input to an encryption result at the encryption output according to an encryption mapping; a decryption unit comprising a decryption input and a decryption output for mapping data applied to the decryption input to a decryption result at the decryption output according to a decryption mapping which is inverse to the encryption mapping; and a controller for applying a first part of the data to be encrypted to the encryption input and a second part which is different from the first part of the data to be encrypted to the decryption input in order to obtain the encrypted data.

In accordance with a third aspect, the present invention provides a device for decrypting data to be decrypted into decrypted data, having an encryption unit comprising an encryption input and an encryption output for mapping data applied to the encryption input to an encryption result at the encryption output according to an encryption mapping; a decryption unit comprising a decryption input and a decryption output for mapping data applied to the decryption input to a decryption result at the decryption output according to a decryption mapping which is inverse to the encryption mapping; and a controller for applying a first part of the data to be decrypted to the decryption input and a second part which is different from the first part of the data to be decrypted to the encryption input in order to obtain the decrypted data.

In accordance with a fourth aspect, the present invention provides a method for encrypting data to be encrypted into encrypted data on the basis of an encryption unit comprising an encryption input and an encryption output for mapping data applied to the encryption input to an encryption result at the encryption output according to an encryption mapping, and a decryption unit comprising a decryption input and a decryption output for mapping data applied to the decryption input to a decryption result at the decryption output according to a decryption mapping which is inverse to the encryption mapping, with the step of applying a first part of the data to be encrypted to the encryption input and a second part which is different from the first one of the data to be encrypted to the decryption input in order to obtain the encrypted data.

In accordance with a fifth aspect, the present invention provides a method for decrypting data to be decrypted into decrypted data on the basis of an encryption unit comprising an encryption input and an encryption output for mapping data applied to the encryption input to an encryption result at the encryption output according to an encryption mapping, and a decryption unit comprising a decryption input and a decryption output for mapping data applied to the decryption input to a decryption result at the decryption output according to a decryption mapping which is inverse to the encryption mapping, with the step of applying a first part of the data to be decrypted to the decryption input and a second part which is different from the first part of the data to be decrypted to the encryption input in order to obtain the decrypted data.

In accordance with a sixth aspect, the present invention provides a computer program having a program code for performing one of the above mentioned methods, when the computer program runs on a computer.

It is the finding of the present invention, that it is basically not disadvantageous for the security of an encryption, if for the encryption a predetermined encryption algorithm or a decryption algorithm which is inverse to the same is used. Both, the application of an encryption algorithm and also the application of a decryption algorithm which is inverse to the same to one datum leads to the same result, i.e. that the encryption or decryption result, respectively, i.e. the cipher text, only allows a potential attacker to draw conclusions to the original datum at a very high expense.

Considering this, it was now another finding of the present invention that this same applicability, both of the encryption and also of the decryption algorithm inverse to the same, as an encryption definition allows to use encryption unit and decryption unit of an encryption/decryption device both, and even simultaneously, i.e. overlapping in time, in an encryption process, if a part of the data to be encrypted is supplied to the encryption unit while the other part is supplied to the decryption unit. The result is encrypted data or is a cipher text, respectively, whose parts were merely “encrypted” in different ways. In the decryption, like e.g. when loading encrypted data from a memory, it only has to be guaranteed by suitable regulations that those parts which were encrypted by the encryption unit are again decrypted by the decryption unit, while the other parts which were “encrypted” by the decryption unit are “decrypted” by the encryption unit. In this regard, the encryption unit may also be regarded neutrally as a first mapping means with a first mapping and the decryption unit may be regarded as a second mapping means with an associated mapping which is inverse to the first mapping.

As now the encryption unit and the decryption unit or the encryption algorithm and the decryption algorithm, respectively, may be used temporally overlapping next to each other both in encryption and also in decryption and not only individually as in the past, the data throughput rate both in encryption and also in decryption may be doubled. In this approach, the security of the data is surprisingly not decreased by the inventive encryption/decryption scheme. In particular in memory ciphering or deciphering, respectively, or memory encryption and decryption, respectively, a doubled data throughput rate forms an enormous performance increase.

### BRIEF DESCRIPTION OF THE DRAWINGS

In the following, preferred embodiments of the present invention are explained in more detail with reference to the accompanying drawings, in which:

FIG. 1 shows a schematical view of an encryption/decryption device according to an embodiment of the present invention for illustrating its functioning with the background of an encryption;

FIG. 2a shows a schematical view for illustrating the temporally overlapping operation of the encryption and decryption unit of the encryption/decryption device of FIG. 1;

FIG. 2b shows a schematical view for illustrating the temporal processing in the encryption according to the encryption/decryption device of FIG. 1;

FIG. 3 shows a schematical view of the encryption/decryption device of FIG. 1 for illustrating its functioning with regard to a decryption;

FIG. 4 shows a block diagram of an encryption/decryption device for a memory encryption according to an embodiment of the present invention; and

FIG. 5 shows a block diagram of an encryption/decryption device with a separately operating encryption unit for encryption and a decryption unit for decrypting.

### DESCRIPTION OF THE PREFERRED EMBODIMENTS

The following embodiments described with reference to the figures assume that the encryption scheme is based on a block cipher scheme, i.e. a scheme in which data to be encrypted are encrypted block by block, i.e. are organized in data blocks and the same are mapped block by block, according to a certain encryption transformation or encryption mapping, respectively, to encrypted data blocks. These block cipher schemes are also referred to as substitution ciphers. The present invention is, however, not limited to such block cipher schemes and neither to symmetrical key encryptions, in which encryption and decryption keys of the encryption and decryption part are equal. It is only of importance that the decryption mapping of the decryption part is inverse to the encryption mapping of the encryption part. For example, the vector \vec{x} is the data block to be encrypted. \vec{x} may take any value, wherein \vec{x} ε X. E is the encryption mapping. E maps any \vec{x} ε X to encrypted data blocks \vec{y} ε Y and is preferably an extremely non-linear mapping. The data blocks \vec{x} may be n bit data blocks which are mapped by E to m bit data blocks \vec{y}, wherein m, n ε |N, wherein m may be larger n or m=n. n>m is also possible if only 2^{m} of the 2ⁿ possible n bit data blocks are allowed. The decryption mapping D, defined on the image amount E(\vec{x})εY and mapping to X, is then the mapping of Y to X for which the following holds true: D(E(\vec{x}))=\vec{x} for all \vec{x} ε X. Simultaneously, the following holds true: E(D(E(\vec{x})))=E(\vec{x}) for all \vec{x} ε X. It is to be noted, that it is not necessary that X and Y be the same spaces, or that E be a bijective mapping. In other words, it only has to be given that the decryption mapping again maps an encrypted datum which was obtained by the encrypting mapping from an original datum, to the original datum again, namely for all admitted original data from X. Of course, preferably E should be different from D, i.e. E should not be self-inverting.

Before the present invention is explained in more detail with reference to the drawings by use of embodiments, it is noted that in the figures identical or similar elements are designated by identical or similar reference numerals, and that a repeated description of those elements is omitted in the following.

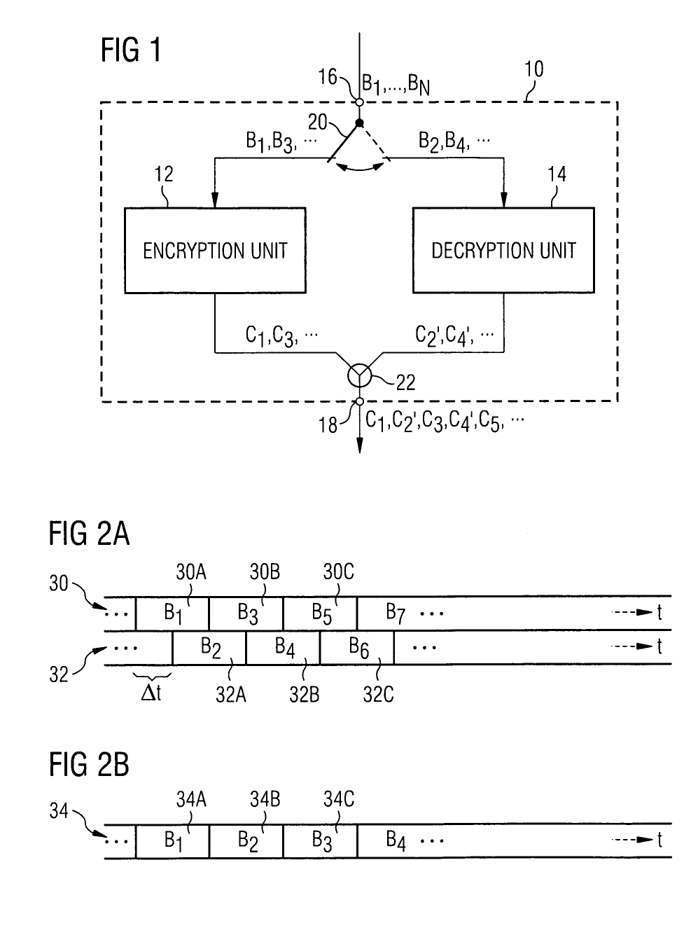

FIG. 1 shows the part of an encryption/decryption device 10 relevant with regard to the encryption according to an embodiment of the present invention. The encryption/decryption device 10 includes an encryption unit or an encryption part 12, respectively, and a decryption unit or a decryption part 14, respectively. Further, the device 10 includes a data input 16 for receiving data blocks to be encrypted B1, . . . , B_{N}, wherein N ε |N, and a data output 18 for outputting correspondingly encrypted data blocks. The device 10 further includes a switch 20, like e.g. a multiplexer, connected between the data input 16 and an encryption input of the encryption unit 12 on the one hand and the data input 16 and a decryption input of the decryption unit 14 on the other hand, in order to distribute the data blocks to be encrypted B1, . . . , B_{N} to the encryption unit 12 or the decryption unit 14 in a controlled way, as it is discussed in more detail in the following. A data output of the encryption unit 12 and a data output of the decryption unit 14 are respectively connected to an input of a merging means 22 whose output is again connected to the data output 18. The merging means 22 merges the data blocks representing the encryption result or decryption result, respectively, of the encryption unit 12 or the decryption unit 14, respectively, with a uniform output data block stream, and outputs the same to the data output 18.

As above the setup of the encryption/decryption device 10 was described with regard to the part relevant for the encryption, in the following its functioning in the encryption of the data blocks B₁ . . . B_{N} to be encrypted is described. The data blocks B₁ . . . B_{N} are serially supplied to the data input 16 as a clear text data stream, i.e. first B₁, then B₂, etc. The switch 20 is controlled to alternatingly supply arriving data blocks to the encryption or the decryption unit 12 or 14, respectively. Which of the data blocks is supplied to which of the two units 12 or 14 is determined by a suitable regulation and for example depends on the application environment in which the encryption/decryption device 10 is used. If the encryption/decryption device 10 is for example used for an encrypted storage, it may for example be the case that the data blocks B₁ . . . B_{N} are always a fixed number of addressable units, from which the pages of a memory organized in pages are assembled. If a page is stored, then the fixed number of data blocks is supplied to one side of the encryption/decryption device 10 in a predetermined order. In this case, the switch 20 for example always supplies the first data block first to the encryption unit 12, the second data block B₂ to the decryption unit 14, the third data block B₃ to the encryption unit 12, etc., as it is also illustrated in FIG. 1. When reading out this page, due to the fixed order in storing the page and the fixed precondition to have the first of the data blocks encrypted by the encryption unit 12, in the decryption the used distribution order is known again, i.e. which data block was “encrypted” in which way, as it is discussed in more detail in the following.

Of course, it is also possible with other applications to use suitable protocols between the encryption/decryption device 10 and the external device (not shown) connected to its data input 16 or the like in order to provide a suitable transparency with regard to which data block was supplied to which of the units 12 or 14, respectively, in the encryption.

Effectively, thus the switch 20 separates the data B₁ . . . B_{N} to be encrypted into two, preferably equally-sized parts, i.e. B₁, B₃, . . . , or B₂, B₄, . . . , respectively, of which the former are supplied to the encryption unit 12 and the latter to the decryption unit 14.

The encryption unit 12 and the decryption unit 14 now process the data blocks supplied to the same at their inputs block by block, in order to map the same to data blocks representing an encryption result or a decryption result, respectively, and output the same at their respective data output. In particular, the encryption unit 12 maps each data block Bᵢ at its encryption input according to an encryption mapping E (E for encryption) to a data block Cᵢ representing an encryption result, with 1≦i≦N. The data blocks output by the encryption unit 12 in response to receiving the data blocks B₁, B₃, . . . , which represent the respective encryption result, are represented in FIG. 1 by C₁, C₃, . . . In other words, the following holds true C₁=E(B₁), C₃=E(B₃), etc. With regard to this part of the data stream B₁ . . . B_{N} to be encrypted, there is consequently no difference to the encryption/decryption device of FIG. 5 in the result, i.e. the encrypted data blocks.

The switch 20 now, however, passes on the other part of the data stream B₁ . . . B_{N} to be encrypted, as described above, to the decryption unit 14. The decryption unit 14 maps each data block arriving at its decryption input according to a decryption mapping D (D for decryption) to a data block representing a decryption result and outputs the same to its decryption output. As shown in FIG. 1, from the data blocks B₂, B₄, . . . at the decryption input a sequence of data blocks results C_{2′}, C_{4′} . . . at the decryption output of the decryption unit 14, wherein C_{2′}=D(B₂), C_{4′}=D(B₄), . . . . The decryption mapping D is, as already mentioned above, a mapping inverse to the encryption mapping E, which means that the same maps a data block, to which the encryption mapping maps an original data block, always again back to the original data block.

With regard to this branch or with regard to this part, respectively, of the data stream to be encrypted, consequently in the result the encryption of FIG. 1 is different from that of FIG. 5. Instead of only supplying encrypted data blocks to the decryption unit 14 in order to reverse the encryption by the encryption unit 12, as it is usual, the decryption unit 14 in the encryption/decryption device 10 is applied to unencrypted data blocks B₂, B₄, . . . , which is in effect equal to an “encryption”, which is why the output data blocks of the decryption unit 14 in FIG. 1 are also designated by Cᵢ′, with “C” standing for cipher, wherein the apostrophe indicates the unorthodox redefinition of the decryption mapping as an encryption mapping.

The data blocks C₁, C₂′, C₃, C₄′, etc. output by the units 12 and 14, are merged by the merging means 22 to a uniform cipher data stream and output at the output 18 of the device 10, like for example to a memory or, however, to a transmission path to a communication partner with a device corresponding to the device 10.

As above, with reference to FIG. 1, the functioning of the device 10 with regard to the encryption of an input data stream from data blocks B₁ . . . B_{N} was described with regard to the overall encryption result or the cipher text C₁, C₂′, C₃, C₄′, etc., in the following the temporal course in the processing of the incoming data blocks B₁ . . . B_{N} is described in more detail in order to be able to better illustrate the advantages of the device 10 of FIG. 1 with regard to those of FIG. 5, wherein for this purpose reference is made to FIGS. 2a and 2b.

FIG. 2a schematically shows the temporal course of the data block processing in the device 10 of FIG. 1 or, expressed in more detail, when which of the encryption units 12 or 14, respectively, processes which one of the input data blocks Bᵢ, in order to map the same according to the encryption or decryption mapping, respectively. In an upper line 30, FIG. 2a here first shows the temporal course of the processing of the input data blocks Bᵢ along a horizontal time axis t by blocks 30a, 30b, 30c, etc., by each time block 30a-30c being labeled by B₁, B₃, B₅, etc. The time axis t runs from left to right. Data blocks processed in time blocks 30a-30b further to the left are thus processed earlier in time by the encryption unit 12 than those in time blocks further to the right. In FIG. 2a, the processing of the data blocks B₁, B₃, B₅, B₇, etc. supplied to the encryption unit 12 was illustrated so as if their processing respectively took the same period of time and as if their processing was directly successive without pauses.

In a line 32 below, FIG. 2a shows time blocks 32a, 32b and 32c, in which the data blocks B₂, B₄, etc., supplied to the decryption unit 14 are processed, wherein each time block 32a-32c is again labeled with the respective data block processed in the respective time block. Also in this line, the time axis t runs from left to right, so that the time blocks lying further to the left take place earlier in time than those lying further to the right. As it may be seen from FIG. 2a, it is also assumed for the decryption 114, that the decryption process for each arriving data block B₂, B₄, etc., takes approximately the same time, and also the same time as the encryption, and that the processing of the data blocks received by the decryption unit 14 is directly successive.

As it easily results from FIG. 2a, the use of both encryption units 12 and 14 to encrypt the incoming data blocks substantially enables to half the overall time period required for the encryption of all incoming data blocks B₁ . . . B_{N}. The reason for this is that the decryption unit 14 is not idle while the encryption is performed but operates in parallel to the encryption unit 12.

Compared to the temporally overlapping operation of the encryption unit and the decryption unit 12 and 14 in the encryption in the device 10, FIG. 2b shows the temporal course in the processing in an encryption for the device of FIG. 5. FIG. 2b shows temporally successive time blocks 34a, 34b, 34c, etc in one line 34. The time axis t here also runs from left to right, so that the time blocks further left again occur earlier than time blocks further to the right. The time blocks are labeled by B₁, B₃, B₅, etc. as the data blocks B₁ . . . B_{N} to be encrypted supplied to the encryption unit 902, in order to illustrate in which time block the encryption unit 902 encrypts which data block. In FIG. 2 it was assumed, that the encryption unit 902 requires the same time period and exactly the same time period for each data block to be encrypted which also the encryption unit 12 and the decryption unit 14 of FIG. 1 require. Also the encryption unit 902 processes the incoming data blocks directly successively according to the example of FIG. 2b.

As it may be seen, however, the encryption unit 902 of FIG. 5 has double as many data blocks to encrypt than the encryption unit 12. The time period for the encryption of incoming data blocks B₁, . . . , B_{N} for the device of FIG. 5 is consequently double as long as that of FIG. 1.

Again returning to FIG. 2a, it is to be noted that here the time offset Δₜ between the processing of a data block by the encryption unit 12 and the respective subsequent data block was illustrated by the decryption unit 14 so as if this time offset was half of the time period for processing a time block 30a or 32a, respectively, that this is not necessarily so, however.

The connection which connects the data input 16 of the device 10 to the external device (not shown) transmitting the data blocks B₁ . . . B_{N} to be encrypted, and on which the data blocks B₁ . . . B_{N} are serially transmitted, may for example be the external bus of an 88 micro-controller with its special bus timing or also a standard bus system, so that the offset Δₜ depends on the bus timing. It may for example be the case, that the device 10 tells the external device by an enable signal when the unit, which has to process the next data block to be encrypted, i.e. the encryption unit 12 or the decryption unit 14, is ready for the next processing, so that in this case the time offset Δₜ is basically only equal to the time period between the transmission of two successive data blocks on the bus which is connected to the data input 16. In this case, thus the first two data blocks B₁ and B₂ of the input data stream would be directly transmitted to the encryption unit and the decryption unit 12, 14 with a slight offset in the order of magnitude of the duration of the transmission of the individual data blocks on the bus to the encryption unit 12 and the decryption unit 14, whereupon the device 10 would temporarily deactivate the release signal until the encryption unit 12 is receptive again, etc.

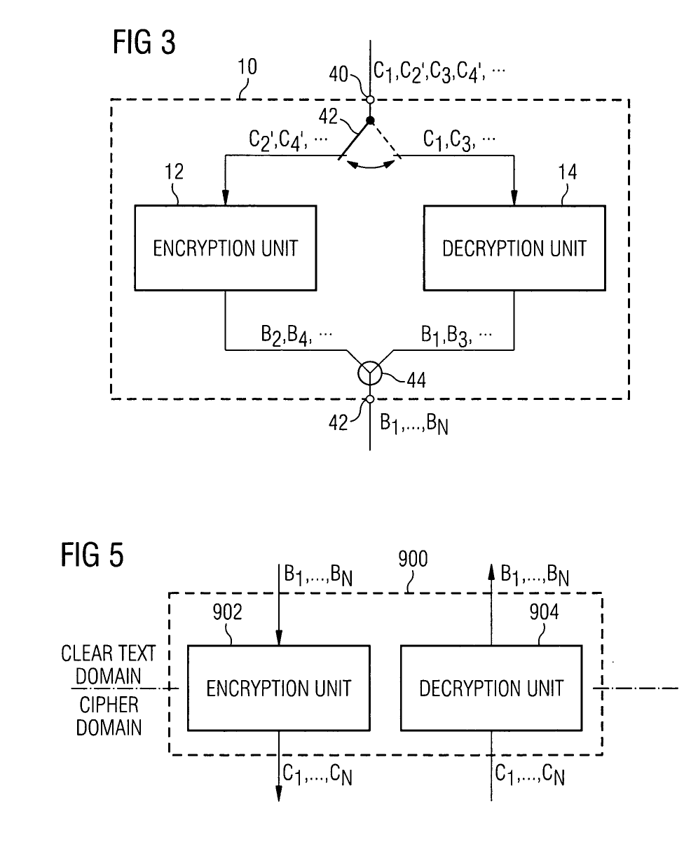

After above the device 10 of FIG. 1 was described with regard to the encryption, with regard to FIG. 3 that part of the device 10 is described which takes part in the decryption. Again, the encryption unit 12 and the decryption unit 14 of the device 10 are shown. Although as a data input for the data blocks to be decrypted the same input might be used, like in FIG. 1 for the data blocks to be encrypted, in FIG. 3 a data input of the device 10 for the data blocks to be decrypted is designated by a new reference numeral, i.e. 40. Also the data output of the device is designated by a new reference numeral in FIG. 3, namely 42, at which the decrypted data blocks are output. It would of course also be possible to use the same output for outputting the decrypted data blocks like in FIG. 1 for the encrypted data blocks, i.e. the data output 18.

The data input 40 of the device 10 is connected either to the encryption input of the encryption unit 12 or the decryption input of the decryption unit 14 via a switch 43. As it will be discussed, the switch 43 is controlled just like the switch 20 of FIG. 1, in order to supply the incoming data blocks to be decrypted alternatingly to the encryption or decryption unit, respectively, 12 or 14, respectively. The outputs of the units 12 and 14 are again connected, via a merging means 44, to the data output 42 of the device 10, which generates a uniform data stream of decrypted data blocks from the data blocks output at the outputs of the units 12 and 14.

As above the setup of the device 10 with regard to the part relevant for the decryption of a cipher data stream was described, its functioning in decryption is now described. At the data input 40 the data blocks to be decrypted are serially supplied in a cipher data stream. In FIG. 3 it is assumed that the data stream to be decrypted is the cipher data stream generated in FIG. 1, i.e. C₁, C₂′, C₃, C₄′, . . . . These data blocks for example represent the encrypted data of one page of a memory which is to be read out.

The switch 43 now distributes the incoming data blocks alternatingly either to the decryption unit 14 or the encryption unit 12. To which of the units 12 or 14 the switch 43 is to direct the first data block, it learns from a control signal from a control means (not shown). This control means knows which of the data blocks was encrypted by the encryption unit 12 (non-apostrophed C's) and which ones were “encrypted” by the decryption unit 14 (apostrophed C's), i.e. according to predetermined rules, a predetermined protocol, a norm, a standard or the like, as it was briefly illustrated above.

In the present case, the switch 43 is controlled such that it passes on the first of the incoming data blocks to the decryption unit 14, as this data block, namely C₁, was generated by the encryption unit 12. The decryption unit 14 thus successively obtains the sequence of data blocks C₁, C₃, . . . . On the other hand, the encryption unit 12 obtains the sequence of data blocks C₂′, C₄′, . . . .

The decryption unit 14 now maps all data blocks arriving at its decryption input block by block according to the decryption mapping D to the data blocks illustrating the corresponding decryption result, i.e. C₁ to D(C₁)=D(E(B₁))=B₁, C₃ to D(C₃)=D(E(B₃)) . . . . The decryption unit 14 thus maps the incoming cipher data blocks to corresponding clear text data blocks B₁, B₃ as it performs the inverse mapping to the encryption mapping, and outputs the same to its decryption output.

The remaining data blocks of the cipher data stream, i.e. C₂′, C₄′, . . . are now obviously supplied to the encryption unit 12, as the same were “encrypted” by the decryption unit 14 according to the embodiment of FIG. 1. Accordingly, they are only “decrypted” by the encryption unit 12. The encryption unit 12 maps each incoming data block at its encryption input according to the encryption mapping E to a data block representing an encryption result, in this case the cipher data block C₂′ to E(C_{2′})=E(D(B₂))=B₂, the cipher data block C₄′ to E(C₄′)=E(D(B₄))=B₄, etc. The same are then output at the encryption output of the encryption unit.

The data blocks output by the units 12 and 14 consequently again represent the clear text data blocks B₁ . . . B_{N}. They are merged to a uniform clear text data stream in the merging means 44 and output at the data output 42.

The encryption unit 12 and decryption unit 14 are also equally operating on the decryption described with reference to FIG. 3, so that also here by the parallel processing of data blocks consecutive in pairs, the overall decryption time period may substantially be halved as compared to the encryption/decryption device of FIG. 5.

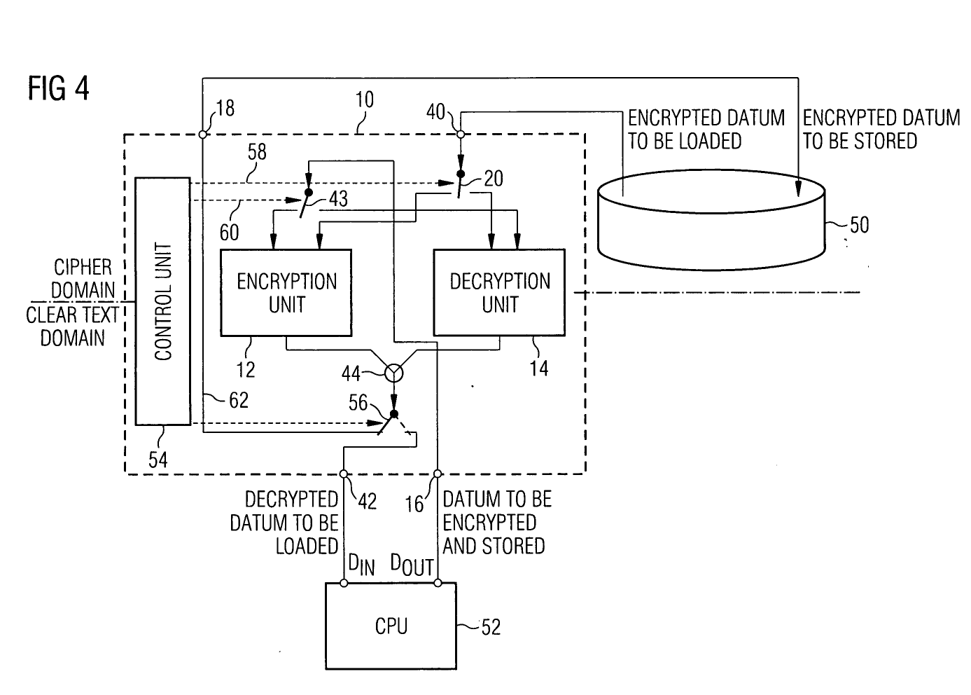

In FIG. 4, an embodiment for an application of the device 10 of FIGS. 1 and 3 is shown. In this embodiment, the encryption/decryption device is responsible for the encrypted storage of data on a memory 50. The data to be stored are stored on the memory 50 from a CPU 52 and are read from the memory 50 by the CPU. The device 10 forms the interface between memory 50 and CPU 52. The part of the device 10 to the memory 50 is the cipher domain in which the data is merely present in encrypted form, while the part between the device 10 and the CPU 52 is the clear text domain, in which the data is present in clear text. An attacker reading out the memory 50 consequently only reaches information in encrypted form, which would mean a very high effort for him to spy out this information.

In FIG. 4, apart from the elements of the encryption/decryption device 10 already shown in FIGS. 1 and 3, further a control unit 54 and a switch 56 of the device 10 are shown. The switch 56 is connected between the output of the merging means 44 and the data output 42 of the device 10 on the one hand and the data output of the merging means 44, which is in this case identical to the merging means 22 of FIG. 1, and the data output 18 on the other hand, in order to combine the data blocks from the encryption unit 12 or the decryption unit 14, respectively, representing the encryption or decryption result, respectively, by the merging means 44 into a uniform data stream and pass on these data blocks either to the output 42 or the output 18.

The control unit 54 influences the switching processes of the switches 20, 42 and 56 by the control signals 58, 60 and 62, respectively, as it is explained in the following.

The data output 18 and the data input 40 are connected to the memory 50, while the data output 42 and the data input 16 are connected to the CPU 52.

As above the setup of the arrangement of encryption/decryption device 10, memory 50 and CPU 52 was described, in the following the functioning of the complete arrangement is described. First of all, the process is regarded that the CPU 52 outputs data to be encrypted and to be stored to its data output Dₒᵤₜ in order to store the same on the memory 50. Via the data input 16 of the device 10, these data then reach the switch 43. As it was described with reference to FIG. 1, then the control unit 54 controls the switch 43 such that it passes a part of the data to the encryption unit and another part of the data to the decryption unit. The parts thus encrypted using different encryption mappings “E” or “D”, respectively, are then combined by the merging means 44 to a uniform data stream. The control unit 54 controls the switch 56 such that this merged data stream now present in an encrypted form is output to the data output 18. The data at the data output 18 is consequently the encrypted data to be stored. The same reach the memory 50 via the data output 18, wherein the same then stores the same in an encrypted form at a corresponding place.

At a later point in time, when processing a program like e.g. an application for example, the CPU 52 may then process a load command which directs to read out the just stored data again and for example load the same into a certain internal register. The CPU 52 thus directs the memory 50 in a suitable way (not illustrated here) to read out the corresponding data again. The memory 50 thereupon outputs the encrypted data to be loaded to the data input 40 of the device 10. As it was described above with reference to FIG. 3, the control unit 54 controls the switch 20 such that the same passes on the incoming encrypted data to be loaded partially to the encryption unit 12 and partially to the decryption unit 14. The parts resulting at the outputs of the same representing an encryption or decryption result, respectively, are again merged by the merging means 44 to a uniform data stream. The control unit 54 controls the switch 56 during this loading process such that it connects the output of the merging means 44 to the data output 42 (illustrated by a dashed line). The decrypted data to be loaded is then passed on, via the switch 56 and the data output 52, to the data input D_{IN} of the CPU 52, which then loads the same into corresponding registers in a known way, at that subjects the same to an addition or the like beforehand in order to process the same now in the form present in clear text.

As it was described above with reference to FIG. 2a or 2b, respectively, the embodiment of FIG. 4 enables to double the data throughput rate in the read and write operations.

The embodiment of FIG. 4 may in particular be applied to the external bus of the 88 microcontroller with its special bus timing. The method my also be integrated in standard bus systems, however, like into the above-mentioned AMBA bus system.

The embodiment of FIG. 4 thus enables, for the write operation and also for the read operation, to use both parts of the encryption/decryption device simultaneously. Basically, this corresponds to a new definition of encryption, as it was already described in more detail with reference to FIGS. 1 and 3, which might be designated as a memory encryption. The data to be encrypted are supplied block by block and one after the other or sequentially, respectively, via a bus, i.e. the one between the data input 16 and the data output Dₒᵤₜ, to the encryption/decryption device 10. Half of the incoming blocks are now encrypted, i.e. processed in the encryption part 12, while the other half of the blocks is “decrypted”, which means, as discussed above, that these blocks run through the decryption part 14. The blocks output by the units 12 and 14 form the memory cipher text. In the read operation something analog happens: the blocks, which ran through the encryption part 12 before, are now supplied to the decryption part 14. The blocks, which before ran through the decryption part 14, are now sent through the encryption part 12. Afterwards, all blocks are again present in clear text. This process, which takes place when loading, may be referred to as a memory deciphering.

The simultaneous use of the encryption and decryption hardware described above with reference to the embodiments, consequently enables the doubling of the data throughput rate without reducing the security of the overall “data encryption”.

With reference to the preceding embodiments it is noted, that the present invention is not only applicable in connection with the encrypted storage. The combination of CPU 52 and encryption/decryption device 10 could also be connected to a further device of encryption/decryption device and CPU, like e.g. a communication partner, like e.g. two communicating telephones, a terminal and a chip card, a control room and a subscriber smart card of an access control system or the like. The encryption/decryption devices would form the interface to the common communication path representing the cipher domain. The data output 18 of the one encryption/decryption device would be connected to the data input 40 of the other encryption/decryption device and vice versa. If a microcontroller or a CPU, respectively, wants to send information to the other communication partner or the other CPU, respectively, then it does the same via the data output 18. Suitable common predetermined regulations enable the other communication partner or the opposite encryption/decryption device to know which parts of the communicated cipher data stream were “encrypted” by the encryption device and which by the decryption device.

It should be clear that in the case of fixed communication partners where always one is a receiver and the other one a transmitter, the one only requires a control in the encryption/decryption device which may for example perform the encryption described with reference to FIG. 1, while the receiver only requires a control which may perform the decryption described for example with reference to FIG. 3.

All in all, consequently the preceding embodiments provide a bus- and hardware-adapted encryption definition, which will lead to an increase in demand due to its performance increase due to the parallel processing possibility in many application areas.

As it was already briefly indicated above, it is further possible to use the same data input and the same data output for receiving the already encrypted data to be decrypted and the still unencrypted data to be encrypted or for outputting the encrypted and decrypted data, respectively. The control unit of the encryption/decryption device would then be informed for example by a signal whether an encryption or decryption is to be performed. In the case of FIG. 4, for example a data input 16 and a data input 40 and correspondingly also the data output 18 and the data output 42 may be combined. When the CPU then starts a storage operation, it would correspondingly inform the control unit 54 about it, so that it correspondingly performs the control of the input switch 20 or 42, respectively. If the CPU conversely activated a storage operation whereupon the memory outputs encrypted data to the device 10, the CPU 52 correspondingly notifies the control unit 54 using a different signal, which subsequently controls the input switch exactly the other way. The common data output at which either encrypted data or decrypted data is output, might be applied to a bus at which together with the data also information about their destination or addressee, respectively, or the like may be provided.

It is further to be noted that deviating from the above description, data to be encrypted may also be divided differently and not always alternatingly into equally-sized parts.

In particular, it is to be noted, that depending on the conditions, the inventive scheme for an encryption/decryption may also be implemented in software. The implementation may be performed on a digital storage medium, in particular a floppy disk or a CD having electronically readable control signals which may cooperate with a programmable computer system so that the corresponding method is performed. In general, the invention thus also consists in a computer program product having a program code stored on a machine-readable carrier for performing the inventive method, when the computer program product runs on a computer. In other words, the invention may thus also be realized as a computer program having a program code for performing the method, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for encrypting data to be encrypted into encrypted data and for decrypting data to be decrypted into decrypted data, comprising
an encryption unit comprising an encryption input and an encryption output for mapping data applied to the encryption input to an encryption result at the encryption output according to an encryption mapping;
a decryption unit comprising a decryption input and a decryption output for mapping data applied to the decryption input to a decryption result at the decryption output according to a decryption mapping which is inverse to the encryption mapping; and
a controller, for
applying a first part of the data to be encrypted to the encryption input and a second part which is different from the first part of the data to be encrypted to the decryption input in order to obtain the encrypted data, in the case that the device is to perform an encryption, and
applying a part of the data to be decrypted to the decryption input and a second part which is different from the first part of the data to be decrypted to the encryption input in order to obtain the decrypted data, in the case that the device is to perform a decryption.

2. The device according to claim 1, which is coupleable to a memory in order to write the encrypted data to the memory and to read the decrypted data from the memory.

3. The device according to claim 2, wherein the device is designed to perform an encryption when the data to be encrypted is to be stored on the memory, and to perform a decryption when the data to be decrypted is to be read from the memory.

4. The device according to claim 1, wherein the controller is designed to supply the first part and the second part of the data to be encrypted or the data to be decrypted, respectively, to the encryption or decryption input, respectively, such that a processing time period of the encryption unit and a processing time period of the decryption unit overlap.

5. The device according to claim 1, wherein the controller comprises a divider for dividing the data to be encrypted into the first part and the second part and a divider for dividing the data to be decrypted into the first part and the second part.

6. The device according to claim 1, wherein the controller comprises a divider for dividing the data to be encrypted into the first part and the second part and a divider for dividing the data to be decrypted into the first part and the second part, wherein the dividers for dividing are designed to perform the division so that the first and the respective second part comprise a predetermined size, wherein the controller is implemented to repeat the division and the application if further data follows the data to be encrypted or to be decrypted, respectively.

7. A device for encrypting data to be encrypted into encrypted data, comprising
an encryption unit comprising an encryption input and an encryption output for mapping data applied to the encryption input to an encryption result at the encryption output according to an encryption mapping;
a decryption unit comprising a decryption input and a decryption output for mapping data applied to the decryption input to a decryption result at the decryption output according to a decryption mapping which is inverse to the encryption mapping; and
a controller for applying a first part of the data to be encrypted to the encryption input and a second part which is different from the first part of the data to be encrypted to the decryption input in order to obtain the encrypted data.

8. A device for decrypting data to be decrypted into decrypted data, comprising
an encryption unit comprising an encryption input and an encryption output for mapping data applied to the encryption input to an encryption result at the encryption output according to an encryption mapping;
a decryption unit comprising a decryption input and a decryption output for mapping data applied to the decryption input to a decryption result at the decryption output according to a decryption mapping which is inverse to the encryption mapping; and
a controller for applying a first part of the data to be decrypted to the decryption input and a second part which is different from the first part of the data to be decrypted to the encryption input in order to obtain the decrypted data.

9. A method for encrypting data to be encrypted into encrypted data on the basis of an encryption unit comprising an encryption input and an encryption output for mapping data applied to the encryption input to an encryption result at the encryption output according to an encryption mapping, and a decryption unit comprising a decryption input and a decryption output for mapping data applied to the decryption input to a decryption result at the decryption output according to a decryption mapping which is inverse to the encryption mapping, comprising the step of:
applying a first part of the data to be encrypted to the encryption input and a second part which is different from the first part of the data to be encrypted to the decryption input in order to obtain the encrypted data.

10. A method for decrypting data to be decrypted into decrypted data on the basis of an encryption unit comprising an encryption input and an encryption output for mapping data applied to the encryption input to an encryption result at the encryption output according to an encryption mapping, and a decryption unit comprising a decryption input and a decryption output for mapping data applied to the decryption input to a decryption result at the decryption output according to a decryption mapping which is inverse to the encryption mapping, comprising the step of:
applying a first part of the data to be decrypted to the decryption input and a second part which is different from the first part of the data to be decrypted to the encryption input in order to obtain the decrypted data.

11. A computer program having a program code for performing the method for encrypting data to be encrypted into encrypted data on the basis of an encryption unit comprising an encryption input and an encryption output for mapping data applied to the encryption input to an encryption result at the encryption output according to an encryption mapping, and a decryption unit comprising a decryption input and a decryption output for mapping data applied to the decryption input to a decryption result at the decryption output according to a decryption mapping which is inverse to the encryption mapping, comprising the step of:
applying a first part of the data to be encrypted to the encryption input and a second part which is different from the first part of the data to be encrypted to the decryption input in order to obtain the encrypted data,
when the computer program runs on a computer.

12. A computer program having a program code for performing the method for decrypting data to be decrypted into decrypted data on the basis of an encryption unit comprising an encryption input and an encryption output for mapping data applied to the encryption input to an encryption result at the encryption output according to an encryption mapping, and a decryption unit comprising a decryption input and a decryption output for mapping data applied to the decryption input to a decryption result at the decryption output according to a decryption mapping which is inverse to the encryption mapping, comprising the step of:
applying a first part of the data to be decrypted to the decryption input and a second part which is different from the first part of the data to be decrypted to the encryption input in order to obtain the decrypted data,
when the computer program runs on a computer.
